(19) United States
(12) Patent Application Publication
(10) Pub. No.: US 2004/0002993 A1
(43) Pub. Date: Jan. 1, 2004

(54) User feedback processing of metadata associated with digital media files

(75) Inventors: Keith M. Toussaint, Seattle, WA (US); Jason E. D. McCartney, Redmond, WA (US); T. Brian Springer JR., Redmond, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/180,449

(22) Filed: Jun. 26, 2002

(51) Int. Cl. G06F 17/00; G06F 7/00

(52) U.S. Cl. 707/104.1

(57) ABSTRACT

System and methods for processing user feedback data corresponding to digital media files. Client computers execute a media player program for rendering media files to their users. A server receives user-provided data entries relating to content of the media files and performs per field conflict resolution to determine relationships between the entries. Based on the relationships, the server aggregates the data entries and then defines new metadata records from the aggregated data for publishing to the users. The invention is directed to a user feedback data schema.

### TECHNICAL FIELD

The present invention relates to the field of processing data associated with digital media content. In particular, this invention relates to processing user feedback data to improve the media metadata delivered to users in connection with digital media files to enhance user experience.

### BACKGROUND OF THE INVENTION

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Additionally, many computers are equipped with digital versatile disc (DVD) drives enabling users to watch movies.

As users become more familiar with advanced features on their computers, such as those mentioned above, their expectations of the various additional innovative features will undoubtedly continue to grow. Users often desire to receive media metadata, which includes content-related data associated with digital media files such as those from CDs and DVDs. For example, consider a media player software application that enables a user to play a CD on his or her computer. Typical applications allow the user to display track information associated with the CD by clicking on an appropriate user interface (UI). Such track information usually includes track numbers, song titles, playing times, and the like.

Notwithstanding these advances, users will continue to desire further advancements to enhance the media playing experience. For example, existing databases of media metadata, albeit large, are naturally incomplete. The wide and varied tastes of computer users in music, movies, and the like creates the need for an enormous corpus of metadata. Also, the same logical content may have many different physical representations, which makes it difficult to identify and retrieve the correct media metadata for a specific media file. Therefore, it is practically impossible for a single source to maintain all media metadata.

Those skilled in the art are familiar with media metadata services that collect information from users when the service is not able to deliver metadata for the specific, requested media file. In general, the standard approach simply creates an additional entry in the database for each entry provided by an end user. Conventional techniques for gathering user feedback fail to account for multiple entries directed to the same logical collection of media unless the entries themselves are indistinguishable or the physical media files are identical. Moreover, conventional techniques for processing user-provided data entries lack the ability to permit users to submit completely new records, such as for an album not covered by the existing database.

Accordingly, this invention arose out of concerns for providing systems and methods for processing user feedback to improve the breadth and quality of stored metadata and, thus, improve the processing of media content to provide an enhanced, rich, and robust user experience.

### SUMMARY OF THE INVENTION

The invention meets the above needs and overcomes one or more deficiencies in the prior art by providing improved processing of user-provided metadata to enhance user experience when playing various media, including CDs and DVDs. Advantageously, the present invention validates user entries against the body of data in a way that ensures that the final product is accurate and aggregates multiple user entries that are associated with the same logical media into a single database record. One embodiment also creates new entries in the metadata database that would serve these entries up to the entire user community while guarding against publication of erroneous metadata. The invention gives separate consideration to matching, adding, and editing metadata records. Further, the invention advantageously uses performer and album avatars to aggregate user data on a per field basis relative to performer and album, respectively. The album avatar also provides detail level aggregation heretofore unavailable in the prior art. Large scale aggregation techniques of the invention permit counting and maintaining votes per physical media descriptor. Moreover, the features of the present invention described herein are less laborious and easier to implement than currently available techniques as well as being economically feasible and commercially practical.

Briefly described, a method embodying aspects of the present invention includes maintaining a database of metadata records, each corresponding to a media file and relating to its content. Client computers execute a media player program to render the media files to users and the method proceeds by collecting user-provided data entries. These data entries each correspond to a specific media file and relate to its content. The method also includes determining relationships between the data entries, aggregating the data entries based thereon, and defining one or more new metadata records in the metadata database from the aggregated data entries.

In another embodiment, a method of processing metadata includes collecting user-provided data entries and defining a model record from one or more of the data entries. The method defines the model record based on at least one property of content-related data. The method continues with performing per field conflict resolution on the content-related data in the data entries. Based on the per field conflict resolution, the method proceeds to populating the model record and defining one or more new metadata records in the metadata database from the model record.

Computer-readable media having computer-executable instructions for performing methods of processing media content embody further aspects of the invention.

Yet another embodiment of the invention is directed to a system for processing user feedback. The system includes one or more client computers, which execute a media player program for rendering media files to their users, and a server coupled to a data communication network. The system also includes a database of metadata records and a database of user-provided data entries. Each metadata record corresponds to one or more media files and relates to content of the corresponding media file. Likewise, each data entry corresponds to a specific media file and relates to the content of the corresponding specific media file. The server is associated with the databases and receives the user-provided data entries via the data communication network. The server then determines relationships between the data entries and aggregates the data entries based on the relationships. From the aggregated data entries, the server defines new metadata records in the metadata database.

Another embodiment of the invention is directed to a user feedback data schema. According to the invention, the schema has a base table identifying each of a plurality of user-provided data entries collected from one or more client computers. The data entries each correspond to a specific media file and relate to content of the corresponding specific media file. The schema also includes a plurality of tables related to the base table. These other tables organize selected content-related data of the data entries in different tables for feeding directly to a database of metadata records.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of a computer system embodying aspects of the present invention.

FIG. 2 is a block diagram illustrating aspects of metadata publishing by the system of FIG. 1.

FIG. 3 is an exemplary flow diagram illustrating aspects of the operation of the system of FIG. 1.

FIG. 4 is an exemplary flow diagram illustrating further aspects of the operation of the system of FIG. 1.

FIG. 5 is an exemplary flow diagram illustrating yet further aspects of the operation of the system of FIG. 1.

FIG. 6 is an exemplary flow diagram illustrating aspects of a user interface (UI) wizard for collecting user feedback in accordance with one embodiment of the invention.

FIG. 7 is an exemplary user feedback UI in accordance with one embodiment of the invention.

FIG. 8 is an exemplary embodiment of a user feedback data schema in accordance with the present invention.

FIG. 9 is a block diagram illustrating one example of a suitable computing system environment on which the invention may be implemented.

Corresponding reference characters indicate corresponding parts throughout the drawings.

### DETAILED DESCRIPTION OF THE INVENTION

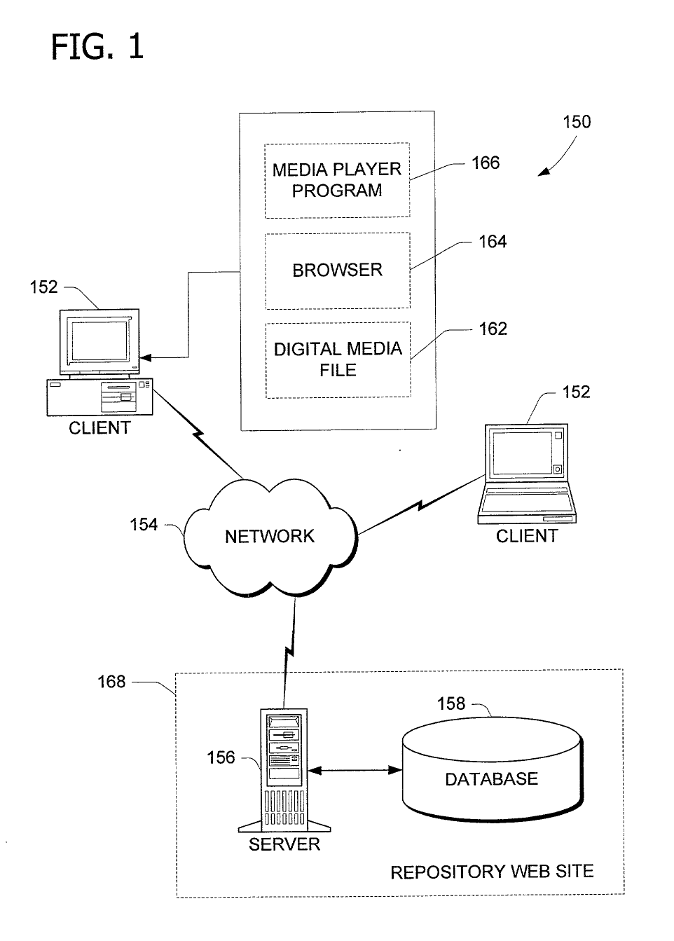

Referring now to the drawings, FIG. 1 illustrates an exemplary network environment in which the present invention can be implemented. A system 150 has one or more client computers 152 coupled to a data communication network 154. One or more server computers 156, sometimes referred to as “web servers” or “network servers,” are also coupled to the network 154. In turn, the client computer 152 can access the server 156 via network 154. As shown in FIG. 1, the system 150 also includes one or more databases 158 associated with server 156.

In this example, network 154 is the Internet (or the World Wide Web). However, the teachings of the present invention can be applied to any data communication network. Server 156 and client computer 152 communicate in the illustrated embodiment using the hypertext transfer protocol (HTTP), a protocol commonly used on the Internet to exchange information.

Referring further to FIG. 1, the user's computer 152 accesses a digital media file 162, such as one residing on a compact disc (CD) or other suitable computer storage media. Client computer 152 also executes a web browser 164 and a media player application program 166. In this embodiment, server 156 and its associated database 158 form a repository web site 168 with which computer 152 communicates via network 154 to access data stored in database 158. The media player program 166 can be any suitable media player that is configured to play digital media so that a user can experience the content that is embodied on the media. For example, suitable media player applications include a CD media player application and a DVD media player application.

One aspect of the present invention enables the user or, particularly, enables media player program 166 executed on a computing device or client, to access, retrieve, and display for the user, so-called metadata. Those skilled in the art are familiar with metadata, which is simply information about data. In the context of the present invention, metadata includes information related to specific content of digital media file 162 being played on the media player 166. Basic metadata includes title, composer, performer, genre, description of content, and the like. Extended metadata includes cover art, performer biographies, reviews, related performers, where to buy similar items, upcoming concerts, ticket sales, URLs to other related experiences including purchase opportunities, and the like.

In the embodiment of FIG. 1, server 156 matches the metadata stored in database 158 to the specific media content that is being experienced by the user. Server 156 then returns the metadata to the user's computer 152. In the examples herein, the media content of digital media file 162 is described in the context of content embodied on a CD or a DVD. It is to be appreciated and understood that the media content can be embodied on any suitable media, including digital files downloaded to the client computer's memory, and that the specific examples described herein are given to further understanding of the inventive principles. For convenience, digital media file 162 refers to one or more files representing, for example, a single song track or a collection of tracks such as would be found on an audio CD. The media content can include, without limitation, specially encoded media content in the form of, for example, an encoded media file such as media content encoded in Microsoft® Windows Media™ format using the Microsoft® Windows Media™ Player program.

Various features of the described systems and methods include a set of databases, client side executable code, and a series of server side processes that provide for querying and maintaining the databases. One logical organization of exemplary system 150 includes a process to map a piece of physical media (embodied by digital media file 162) to a unique database key or, as referred to herein, a “logical ID.” This organization also includes a query process to retrieve information from database 158 based on the unique database key or logical ID. A data return mechanism and schema set returns data and a user feedback system allows users to contribute to the set of understood keys or logical IDs. The logical organization of system 150 also includes a set of management processes that handle user contributions.

The resultant system 150 permits the user to play media file 162 on an enabled media playing device (e.g., computer 152 running Microsoft® Windows® operating system and Windows Media™ Player) and expect not only to experience the media content but also have access to all manner of related metadata. In addition, the user community has the ability to contribute key information to the process to improve the experience for other users.

In system 150, the user on the client side inserts the media into computer 152, or otherwise causes the content of media file 162 to be experienced. Computer 152 uses a physical ID identifying specific media file 162 to access the logical ID that uniquely identifies the media. Server 156 then uses the logical ID as the basis for metadata queries of database 158. These queries are designed to retrieve a rich set of related metadata for the user. Server 156 then returns the metadata to client computer 152 via network 154 for display to the user.

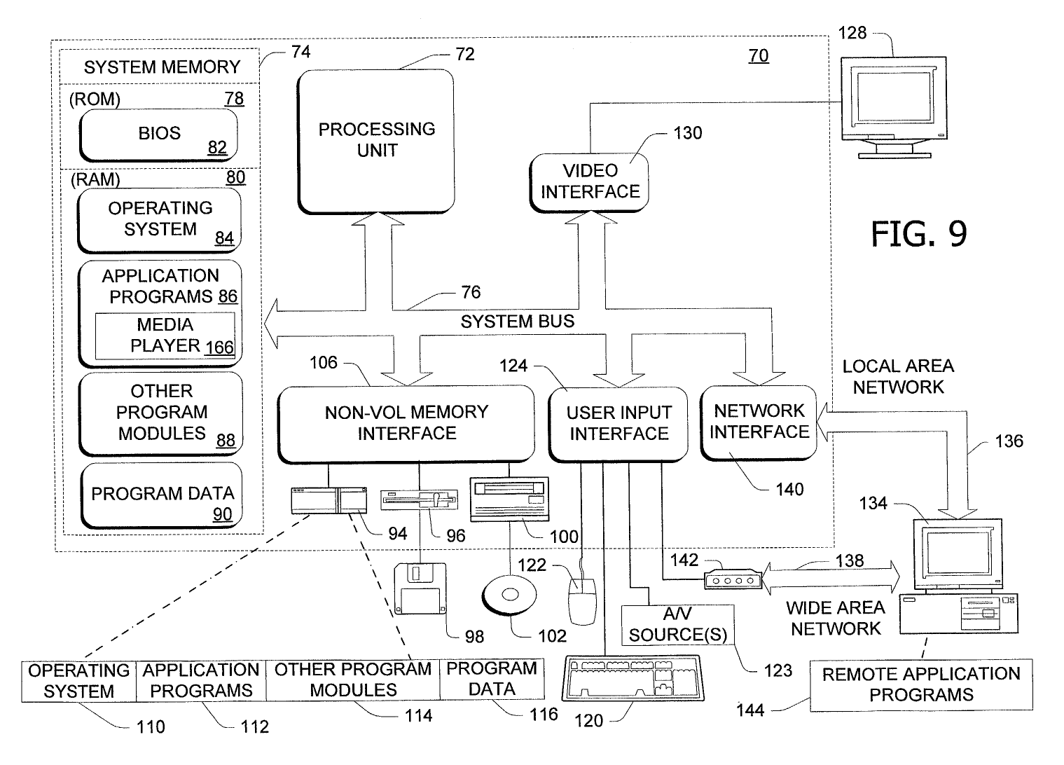

When the user accesses (“rips”) an audio track from a specific digital medium, the ripped track (i.e., digital media file 162) is stored on local storage media associated with the user's computer, such as client computer 152 in FIG. 1 (see also computer 70 in FIG. 9). If client computer 152 is connected to network 154, as described with reference to FIG. 1 and FIG. 9, media player program 166 executing on computer 152 sends an identifier for digital media file 162 to server 156 of repository web site 168 via network 154. As described above, the identifier may take the form of a physical ID such as a table of contents (TOC) identifying the specific digital media file 162 based on the offsets of each track on the disc. The TOC, defined by a well-known specification referred to as the Red Book, identifies an audio CD based on absolute times for the start of each track. The TOC, found in the CD's lead-in area, is expected to be the same for all like-entitled CDs published from the same source. Repository web site 168 has access to database 158. In response to the received TOC (or the mapped logical ID), server 156 transmits metadata associated with the identified media file 162 to the user's computer 152.

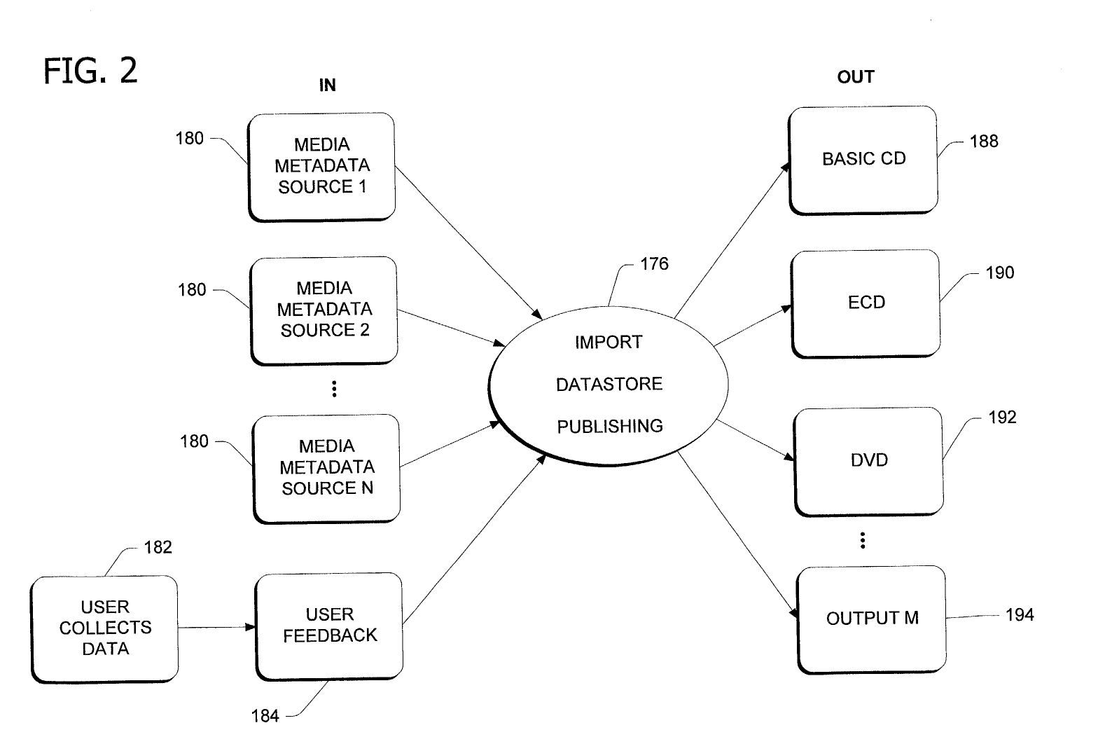

Referring now to FIG. 2, one embodiment of repository web site 168 provides import, datastore, and publishing functions at 176. Typically, known data providers 180 of media metadata (e.g., AMG and Oricon) supply the repository with trusted information. In this instance, data providers 180 specialize in the gathering and management of media metadata and license the data to system 150. Due to the trusted nature of the source, this data is treated as “canonical.”

As an example, popular albums that have been released for many years tend to have well-established metadata. User feedback should not be allowed to change the content of the canonical entries. By weighting the canonical entries appropriately, normal user feedback rules do not apply so even a concerted and coordinated user feedback campaign cannot override these entries.

Referring further to FIG. 2, the user gathers content-related media data directly from a CD, for example, at 182 and then submits the information at 184. In FIG. 2, system 150 publishes metadata in several formats. As shown at 188, published metadata takes the form of basic CD information. System 150 can also publish the data in extended CD format at 190 or DVD format at 192. As indicated at 194, the present invention contemplates other types of data output.

The present invention beneficially scales well to multiple data providers 180. While basic metadata for each digital media type (e.g., CD, DVD) can be considered universal because they are tied to the data standards in the media, extended metadata varies widely among multiple data providers. Many data publishers require full updates of metadata on a regular basis. Thus, integrating multiple data sources into a single extended metadata schema necessitates the complete update of the entire data store each time any one provider refreshed its data set. The present invention solves this dilemma by establishing a single set of tables that contains the basic metadata from all metadata providers 180. This data set is sufficient to service queries and user feedback functionality.

The following table sets forth an exemplary schema for basic CD metadata publication.

TABLE I

| Album Table | Track Table | TOCs Table | Person Table |
|---|---|---|---|
| albumID | trackID | albumID | personID |
| fullTitle | albumID | frames (raw TOC | fullName |
| | | value) | |
| article | trackTitle | source | article |
| sortTitle | article | volume (in a multi- | sortName |
| | | volume set) | |
| performer | performers | | genre |
| genre | composers | | |
| relDate | volume | | |
| totalTime | tracknum | | |
| rating | | | |
| person ID | | | |
| label | | | |
| style (e.g., AMG | | | |
| style) | | | |
| coverfname | | | |
| (location of art) | | | |
| source | | | |

In one embodiment of the invention, maintaining user feedback data for performers and metadata in a separate table provides an opportunity to address known issues without fundamental database redesign. An oft-cited example is the situation where artists with made-up names (e.g., *nSync, 'Nsync, or N'Sync, etc.). Implementing a separate table simplifies including multiple textual entries per personID yet retains the integrity of the data (i.e., adding multiple album rows for each artist's spelling variation would lead to unacceptable data duplication in the album table).

The description below will provide detailed aspects of the above systems and various methods that all contribute to a much richer user experience.

In one described embodiment, each media file 162 in which the content that is to be experienced by the user resides has a physical ID associated therewith. The physical ID is assigned or otherwise associated with a logical ID, which is then used as the basis for any database queries. With respect to the physical IDs that are associated with the media, any suitable method or technique of generating a physical ID can be used. For example, when a user inserts a piece of media into a properly configured and enabled device, software code can execute and read data from the physical media. The software code can then compose a unique or nearly unique physical ID from that data.

In the case where the media comprises a CD, the software code can read the offsets (in frames, which have a resolution of 1/72^{nd} of a second) of each track on the disc. A composite key or physical ID is then built from a string of the hex values of these offsets, prefaced by a number of tracks on the disc and finished with a representation of the total length of the disc.

In the case where the media comprises a DVD, the software code can read the first 64 kilobytes of two files that are guaranteed to be on every DVD. These files are VIDEO_TS.IFO and VTS_{—}01_{—}0.IFO. The former contains main-menu information (VMGI), and the latter contains title set information (VTSI) for the first title on the DVD. After the appropriate data blocks are read, the code generates a 64-bit CRC (cyclic redundancy code) checksum of the data, resulting in an appropriately unique key or physical ID. Of course, it is to be understood that the above two examples are simply two ways that a physical ID can be generated for two different types of media. Other methods of generating physical IDs, as well as other media types can be employed.

Calculation of the physical IDs takes place, in this example, on the client side by software code that executes on client computer 152. Such code can comprise part of a software-implemented media player (e.g., media player program 166) that is configured to play the media of interest.

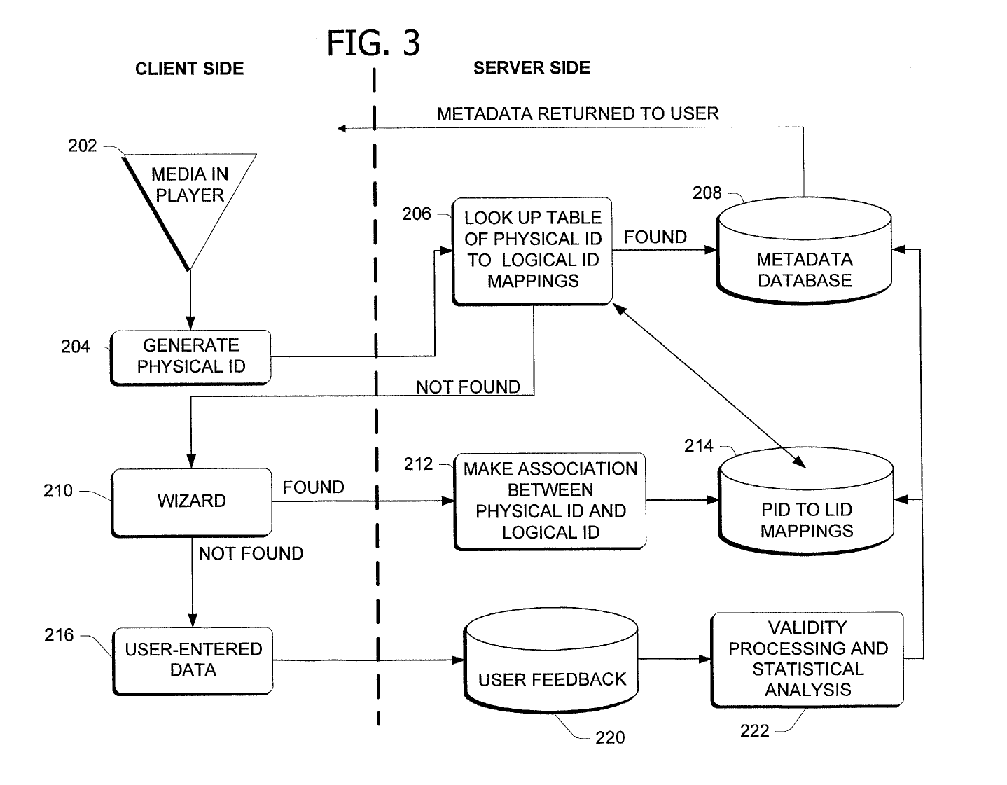

Once the physical IDs are generated, client computer 152 sends the physical IDs to server 156 of the repository web site 168 via network 154 using a suitable protocol. FIG. 3 provides a work flow diagram to assist in understanding the processing that takes place, including generation of the physical IDs. In FIG. 3, the processing takes place on and between the client 152 and the server 156.

At 202, the user accesses a particular piece of digital media using enabled media player program 166, which generates a physical ID for the media at 204. According to one aspect of the invention, accessing the digital media in this manner may include converting the media file to a format compatible with media player program 166 (also referred to as “ripping”). Client computer 152 then bundles up the physical ID and sends it to server 156 for processing. This bundling can be done in any suitable way using any suitable protocols. In one example, the physical ID is passed, through an HTTP URL, to server 156. The server 156 can be configured in any suitable way (e.g., server 156 runs active server pages (ASP) code on the Internet Information Server web services product available from Microsoft Corporation). As will be understood by those skilled in the art, the code can also include a mechanism for converting the ASP request into a query request for a web-enabled database product, which supports for extensible markup language (XML), such as SQL Server also available from Microsoft Corporation.

The server 156 then uses the physical ID to query a lookup table 206 to determine whether there is a proper logical ID associated with it. The logical ID represents the piece of media in a metadata store or database 208 (i.e., database 158). If there is a logical ID associated with the physical ID, then that logical ID serves as a basis for a query of database 208. This query then returns, to the user, metadata associated with the user's media file 162. This metadata comprise a rich collection of data, with non-limiting examples being given above.

As explained above, existing databases of media metadata, albeit large, are naturally incomplete. The wide and varied tastes of computer users in music, movies, and the like creates the need for an enormous corpus of metadata. Also, the same logical content may have many different physical representations, which makes it difficult to identify and retrieve the correct media metadata for a specific media file. Therefore, it is practically impossible for a single source to maintain all media metadata.

For this reason, if server 156 does not find a logical ID for the physical ID, then media player program 166 presents a wizard user interface 210 to the user on the client side for obtaining user feedback. The wizard 210 attempts to find or establish the logical ID for the user's media file 162. For example, assume that the user starts playing a CD that has a physical ID that has not yet been processed by system 150. When server 156 attempts to look up a logical ID associated with the media's physical ID, no corresponding logical ID will be found. Accordingly, client computer 152 presents wizard 210 to the user and attempts to identify the user's media file 162. The wizard 210 attempts to identify the user's media because a logical ID that is associated with the media may already exist. For example, the same entitled CD, containing the same songs, can actually have several different physical IDs associated with it, yet there will be only one logical ID to which all of these physical IDs are mapped. If system 150 has not yet processed the physical ID, it will seek to establish an association between that physical ID and the logical ID that already exists in database 208 for that particular CD.

If client computer 152 successfully identifies media file 162 using wizard 210, and a logical ID for the file exists, then server 156 establishes a physical ID to logical ID mapping at 212. In this embodiment, the mapping is for the specific physical ID of the user's media file 162. Server 156 maps the specific physical ID to the logical ID that is associated with the user's media and stores the association in a database 214 (e.g., database 158) that contains physical ID to logical ID mappings.

On the other hand, if wizard 210 is unsuccessful in identifying the particular media file 162, then server 156 accepts data identifying the media entered by the user at 216. Those skilled in the art are familiar with media metadata services that collect information from users when the service is not able to deliver metadata for the specific, requested media file. However, conventional techniques for processing user-provided data entries lack the ability to permit users to submit completely new records, such as for an album not covered by the existing database. Conventional techniques for gathering user feedback also fail to account for multiple entries directed to the same logical collection of media unless the entries themselves are indistinguishable or the physical media files are identical.

In one embodiment, the user-entered data 216 (e.g., title, tracks and artist) establishes a physical ID to logical ID mapping for media file 162, which in turn serves as a logical ID for all subsequent physical IDs associated with the particular media file 162. Consider, for example, a situation in which a particular user is the first system user to play a new CD. In this case, system 150 may not include a logical ID for the new physical media. Accordingly, media player program 166, through wizard 210, prompts the first user to enter any relevant information for the CD (i.e., title, artist, tracks, track titles, and the like).

In this embodiment, server 156 stores the user-provided data entries 216 in a separate database 220 for processing. The database 220 keeps track of entered data as well as whether the user-provided information was added, edited, or matched. At 222, server 156 performs validity and statistical analysis according to the invention to define a new metadata record corresponding to the specific media file 162 being rendered by media player program 166.

In one embodiment, the wizard UI 210 first assists in identifying a user's specific media so that a physical ID to logical ID mapping can be made. Wizard 210 also assists the user in entering content-related data for the media file 162. Specifically, recall in FIG. 3, that failing, at 206, to locate a physical ID to logical ID mapping, client computer 152 presents wizard UI 210 to assist in the discovery process. The discussion below presents but one embodiment of a wizard for use in accordance with the present invention.

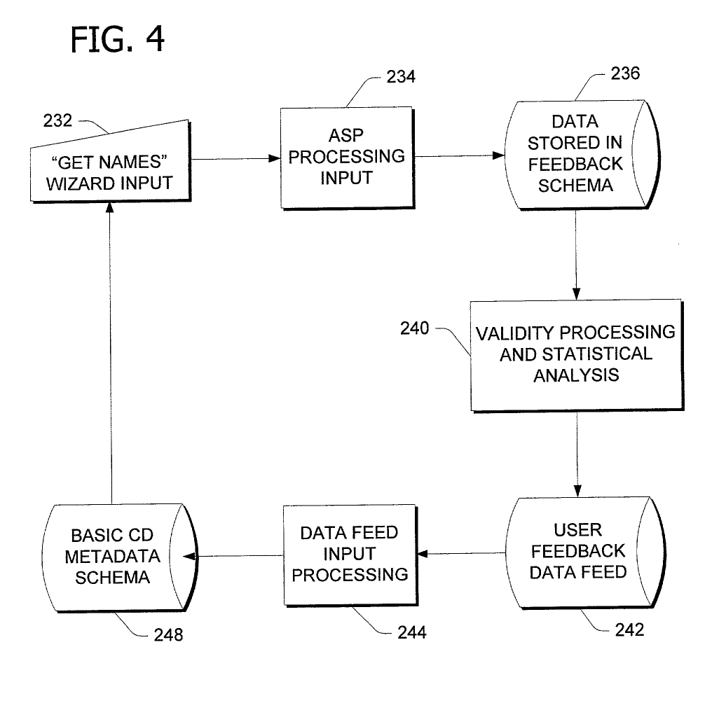

FIG. 4 further illustrates user feedback data flow according to one embodiment of the invention. The overall objective in managing user feedback is for the data provided by users to be integrated into the metadata service for publishing to users. According to the invention, system 150 establishes a basic metadata schema into which the user feedback data can be integrated. In turn, system 150 provides a clean transition between user feedback and published data. Beginning at 232, the user enters content-related data (e.g., via “Get Names” wizard 210). Server 156 processes the entries at 234 via a asp and stores the processed entries into a user feedback schema in the live data center at 236. On a periodic basis (e.g., daily), server 156 executes an automated process at 240 to evaluate the user-provided data entries for determining which items are to be discarded, processed for inclusion in the data publication process, or provided as input to licensed content providers 180. System 150 includes the items that meet the criteria in the data publishing process. At 242, server 156 stores the valid feedback data in a data feed that will be processed at 244 in the same manner that data feeds from content providers 180 are processed. The end result of this processing is to incorporate user data into a basic CD (BCD) metadata schema at 248, which is then made available to the user community.

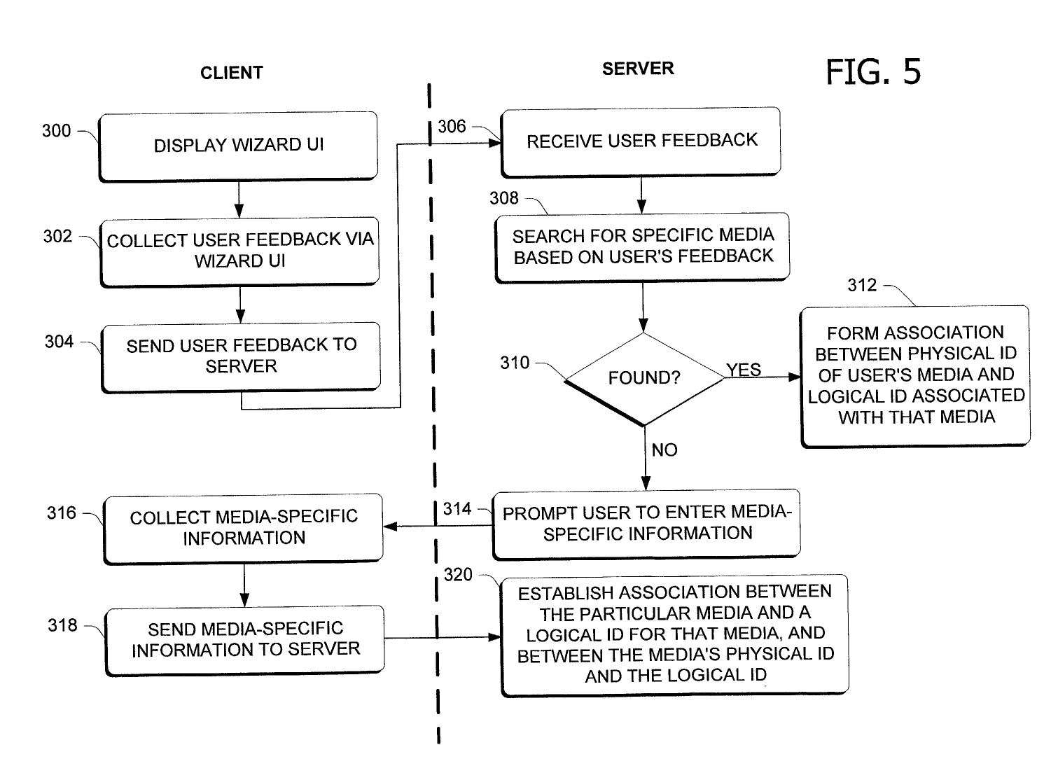

FIG. 5 is a flow diagram that describes operations in a method in accordance with one embodiment (shown at a high level in FIG. 4). The steps can be implemented in any suitable hardware, software, firmware or combination thereof. In the illustrated and described embodiment, the steps are implemented in software. This software can reside on the server side of the system or on the client side of the system. In this particular example, the software resides on the server side of the system, although steps are implemented on both the client and the server side. To this extent, FIG. 5 is divided into two different sections—one labeled “Client” to depict steps that occur on the client side, and one labeled “Server” to depict steps that occur on the server side.

At 300, client computer 152 displays wizard UI 210. The wizard 210 can be implemented in any suitable software. In the illustrated example, the wizard is implemented using Active Server Pages and DHTML. This step can be implemented, in the described embodiment, upon a failure to find a logical ID associated with a physical ID that has been provided by the client. For example, a user might insert a CD (i.e., digital media file 162) into computer 152, where the CD has a physical ID that has not yet been logged in system 150. Because server 156 does not find the physical ID, client computer 152 employs wizard UI 210 to attempt to identify the specific media so that a logical ID can be associated with its physical ID.

At 302, system 150 collects user feedback or information via wizard UI 210. In this instance, wizard 210 attempts to collect specific information associated with the user's media 162. This specific information can include any information used by system 150 to assist it in establishing a physical ID to logical ID mapping. For example, if media file 162 comprises a music CD, the user can provide feedback in the form of the artist's name or album title. At 304, client computer 152 then sends the user feedback to the server 156. Server 156 receives the user feedback at 306 and searches for specific media based on the user's feedback at 308. It will be appreciated and understood that the operations described with reference to 302, 304, 306 and 308 can take place multiple times between the client and server. Such can be the case where, for example, the wizard 210 uses the user's feedback to provide a number of possible selections, and then progressively narrows down the choices based on the user's additional feedback. This will become evident in the example that follows.

If, at 310, a specific media is found to coincide with the user-provided feedback, then 312 forms an association between the physical ID associated with the user's media, and the logical ID associated with that media. Now, whenever the user plays that particular piece of media in their media player, server 156 will be able to use the physical ID to retrieve the associated logical ID, so that it can then query the database(s) 158 that contains the metadata associated with that particular piece of media 162.

If, on the other hand, server 156 is unsuccessful at 310, then the server proceeds to 314 to prompt the user (via wizard UI 210) to enter media specific information about media file 162. Client computer 152 collects the user feedback (e.g., album title, artist, track titles) at 316. Proceeding to 318, client computer 152 sends the media-specific information to server 156, which in turn establishes an association between that particular piece of media and a logical ID for the media at 320. It is to be understood that server 156 may also establish an association between the physical ID for the particular piece of media and the logical ID. Further, it should be noted that the operations described with reference to 314, 316, 318, and 320 can be performed when the user is the first user to play their media in an enabled player and the media has not yet been incorporated into system 150.

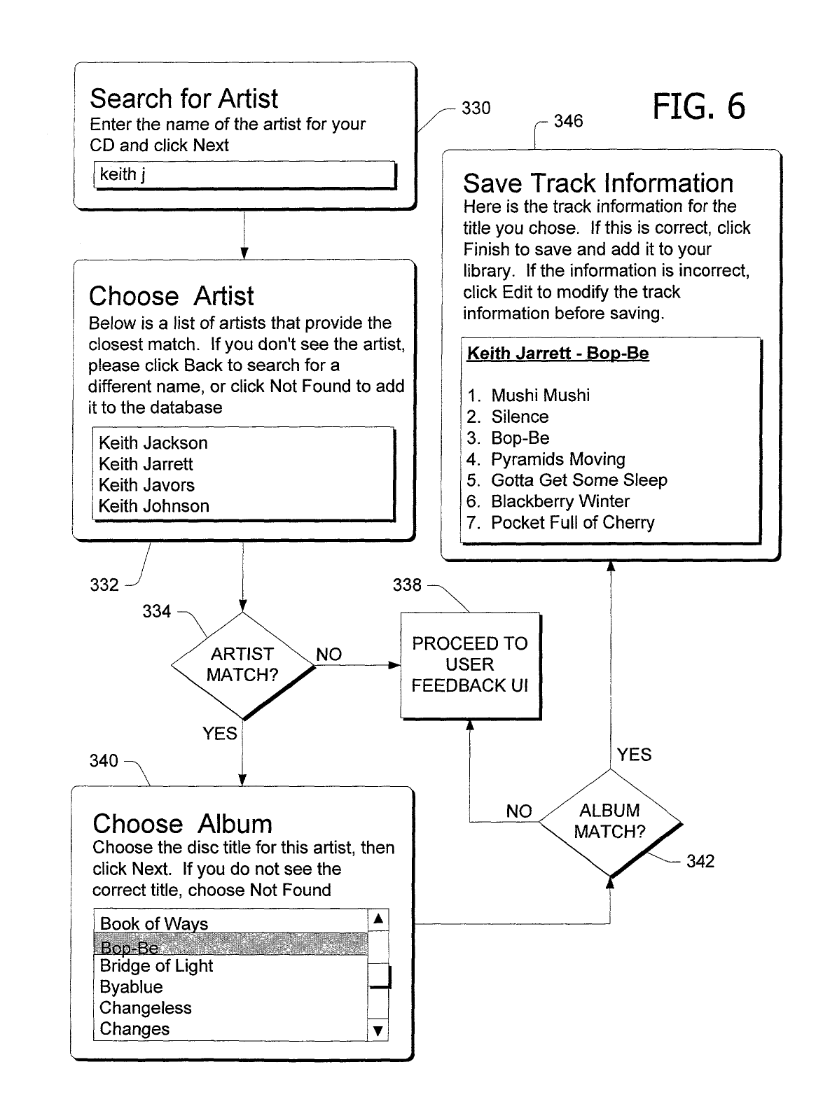

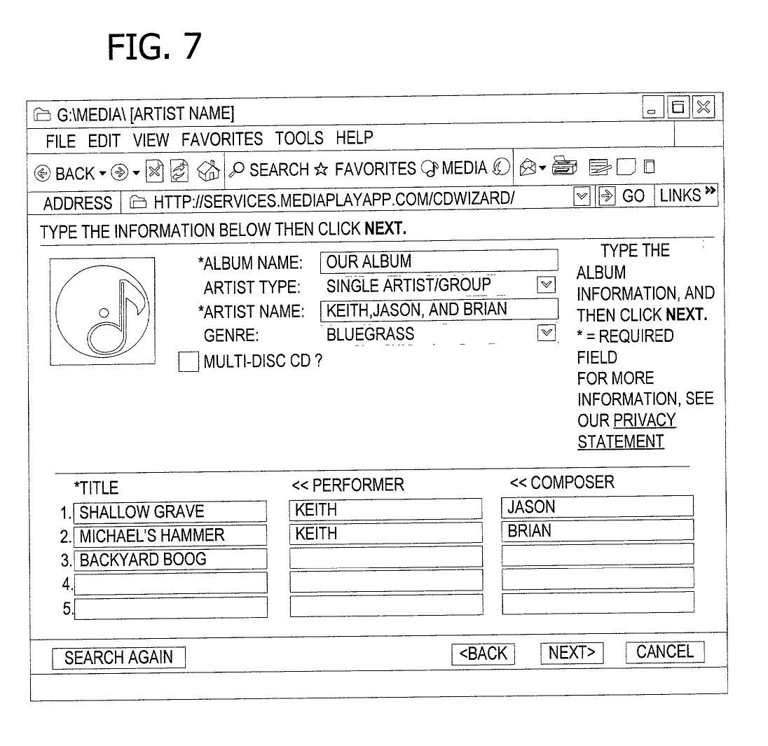

FIG. 6 shows an exemplary wizard UI 210 in flow diagram form. Client computer 152 first displays a start artist search UI 330 (see block 300 in FIG. 5). The wizard 210 proceeds to UI 332 in which the user can provide feedback pertaining to an artist's name for a particular CD inserted into an enabled CD player. Once the user enters the artist's name, client computer 152 provides this information to server 156, which begins searching for a specific media associated with that artist (see block 308 in FIG. 5). Searching for the specific media can take many forms. Additionally, the searching can involve multiple iterations with the user to narrow down search results. If the user cannot match the artist, at 334, the wizard 210 proceeds to a user feedback UI 338 (see FIG. 7). On the other hand, if the artist matches an established artist, wizard 210 presents a UI 340 to the user listing multiple artists that closely match the artist's name entered by the user. If the user matches the artist, the wizard UI 210 shows an album selection UI 340 to the user. The album UI 340 lists various disc titles for the artist that has been confirmed by the user. The user can then select the disc title that corresponds to the CD that they are playing. Once the user selects the appropriate disc title, an association can be made on the server that associates the specific physical ID associated with the user's media, with a corresponding logical ID that can be used as the basis of database searches. If the album matches at 342, a save track information UI 346 confirms the track information for the disc title that was selected by the user.

FIG. 7 provides an exemplary user interface to assist the user in entering content-related data.

It should be appreciated that any system that allows user feedback in this manner necessarily opens itself up to significant risks of tampering, erroneous entries, and other security concerns. In the discussion below, the present invention provides an approach that deals with automatically analyzing user-provided data to be incorporated in such a way that it is reasonably certain to be accurate, and is self-correcting in the case where it is not accurate.

As described above, the database used to store the raw user feedback data (e.g., database 220) is separate from that used to assess what portions of that feedback are applied to our data publication (e.g., database 208). As such, the original data is left untouched and may be re-processed using updated techniques and modified criteria. For example, as the metadata service observes the characteristics of user feedback, it may determine that the usage of a performer, album, or song has a number of common variations. Applying this aspect of the invention permits changing the algorithm used to process the feedback and incorporate this newly observed characteristic.

In other words, one embodiment of the invention maintains statistical reduction tables and archives actual feedback data without losing semantic significance. This enables the metadata service to flexibly apply as little or as much of the entire volume of user feedback data as needed. One major advantage this provides is that server 156 can apply new processing rules to the entire volume of user feedback data at any time.

One embodiment of the invention allows data aggregation in a manner heretofore unavailable through the use of an “avatar.” The avatar, also referred to as a model record, aggregates data entries based on content-related data. As an example, a person avatar aggregates the persons associated with the media file 162 (usually performers) in a way that ensures that system 150 does not add additional records for a performer already in the system. This enables correctly associating the user's entry with the associated extended metadata.

In the process of providing user feedback, users are asked to identify the primary performer on an album based on the existing published database 158. In instances where database 158 does not contain the particular artist, system 150 creates a new entry for the artist. In subsequent user feedback entries, server 156 identifies artists who (based on text matching criteria, for example) represent the same person. In the case where the person does not exist in the published database 158, server 156 selects the earliest entered person (based on the time of the first feedback entry) as the person avatar.

The present invention also contemplates the use of an album avatar. A major advantage of system 150 is the ability to build an accurate collection of data from the pieces of entries applied by separate users. Applying this concept allows system 150 to aggregate media collections (e.g., albums, DVDs) by building an accurate set of detail-level (e.g., track, chapter) aggregations. During the course of processing user feedback, an aggregation of added new album entries is identified. These entries have both a TOC entry and an album entry. In operation, system 150 decides for each of these rows whether it is truly a brand new user entered album or whether it matches an album that is already present in database 158. In making this determination, system 150 determines whether the artist entered for the album is really a new artist or whether it is likely an already existing artist that the user failed to select in wizard 210 (see 332 in FIG. 6) for some reason (person avatar). In one embodiment, server 156 performs a string match on the artist name. In the case of a multiple match, server 156 selects the artist with the most albums.

After associating a new album entry to an artist avatar, server 156 compares entries based on user-entered album title, album performer, number of tracks on the album, track titles, and track volume (applicable when an album belongs to a multi-album set). Using these criteria, server 156 locates a single album of the group that corresponds to the established criteria. This album is made the avatar album for the applicable group.

In one embodiment, system 150 incorporates voting statistics for each of the major components of the media collection (typically tracks in an album). This design enables the invention to construct the best entry for the entire collection by including only the best components of the entire collection. A user voting system determines this assessment of the value of each component of the collection.

The present invention also employs detail-level aggregation techniques, which allow consideration of each part of user feedback information separately and which create a consolidated avatar from multiple user entries. The aspect of the invention that enables track-by-track voting is an extension of this mechanism. The problem with aggregating an entire collection of media is that in order to ensure a quality end product, the entire entry must be identical or so close to identical that it is reasonable to believe that two separate users intended for their entries to be identical. Unfortunately, only a very small percentage of entries for entire albums, for example, will exhibit this behavior. However, it is more likely that two users will get at least a few of the tracks on an album identical. By collecting votes on a track-by-track basis, or on a per field basis, system 150 permits detail-level aggregation without compromising the ability to gather a full collection of data related to the media.

The following Table II illustrates the method:

TABLE II

| | User 1 | User 2 | User 3 |
|---|---|---|---|
| Track 1 | The Shoo Fly song | Shoo fly song | The shoo fly |
| Track 2 | Silly Love Song | Silly Love | Silly Love Song |
| Track 3 | Freebird | Free Bird | Freebird |
| Track 4 | Hey Jude | HeyJude | Jude |
| Track 5 | Take the “A” Train | Take the train | Take the A Train |

In this example, no two full entries are identical enough to conclude that all three users intended the same thing for all tracks. However, on a track-by-track basis, at least two of the three users appear to be saying the same thing. In this case, the invention allows for the matching tracks to obtain the necessary votes to be included in the data publication. Taken together, the entire album is accounted for even though no two users provided the same entry for the entire album.

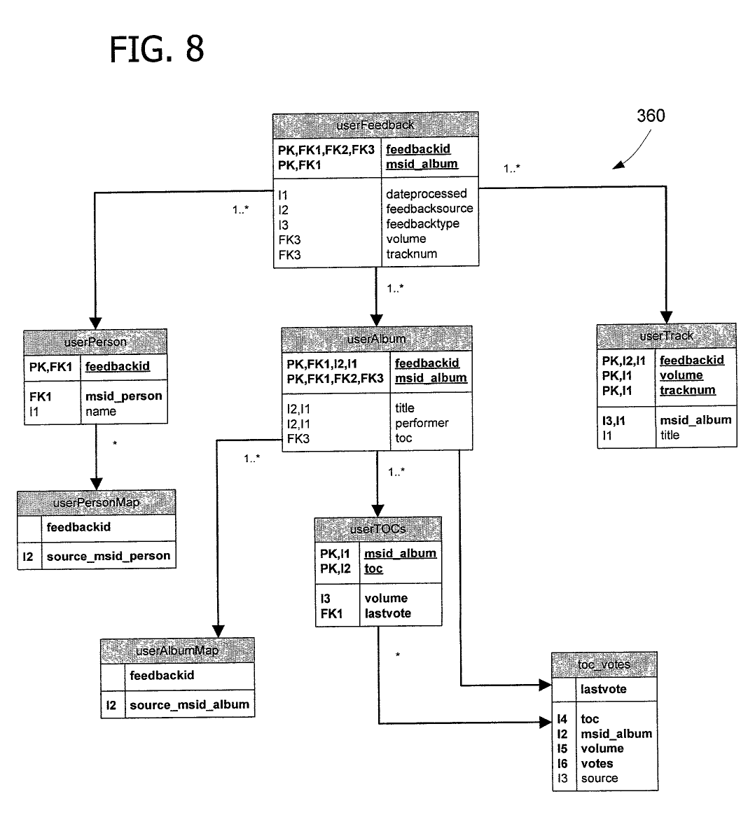

Referring now to FIG. 8, the present invention further provides an improved data schema for user feedback. Advantageously, the user feedback schema depicted in FIG. 8 permits an accurate assessment of what a user actually did during the feedback session, eliminates superfluous data rows included when a user merely navigates through the wizard without making changes, and facilitates global changes because the track data is not found in a single field of an XML document.

The new schema of FIG. 8 addresses these issues by fundamentally changing the way the metadata service collects user feedback. In the present embodiment, server 156 collects user feedback into a relational structure that mimics the basic CD metadata schema. The output of the new user feedback schema can be used directly as a data feed that can then be manipulated and included in the data feed process. Moreover, making feature-based decisions on data priority is much easier.

As shown in FIG. 8, a base table userFeedback expressly accounts for each user feedback entry received by server 156. All other tables in the schema are related to the userFeedback table via feedbackID. A related table, userAlbum, stores new album entries as well as modifications to the album name or performer associated with the album. If the user does not make any changes to the album title or main performer related to the album, there will be no row in this table. Note that this means that if a user makes changes to tracks associated with an album and does not make a change to the album name or primary artist associated with the album, no row will be stored for that feedback entry.

The schema according to one embodiment of the invention also includes a userPerson table and a userTrack table. The userPerson table records new or altered performer names. For new albums that refer to an existing performer in the metadata database, there will be no entry in this table. Similarly, if a user modifies the album title or track information only, there will be no entry in this table. The usertrack table stores additions/changes in tracks only.

Referring further to FIG. 8, the user feedback data schema also includes a userTOCs table, which stores all TOC matches and changes. If the user only changes the metadata values, no entry will be made to this table. In one embodiment, all TOC entries (whether added or updated), the source is considered the user community without regard to whether the metadata associated with the TOC match is from licensed data provided.

In one embodiment of the invention, server 156 executes validity processing rules following the user feedback schema. For example, only changed/updated data appears in the user feedback schema. In other words, if only track information changes, no entry is made in the TOCS table. All row additions/updates are made on a row-by-row basis (as opposed to a column-by-column basis). As such, if a user changes one value in an album or track record, all columns relevant to that record are stored. Specifically, if the user data changes the title of a track but does not change the performer or composer information, the unchanged performer and composer data is also stored in the user feedback record. For track insertions, all subsequent tracks are changed as tracknum will change for each track after the one inserted. Yet another processing rule prevents deletions from being accepted and another preserves canonical data. Advantageously, system 150 retains all user feedback entries, whether or not they are accepted. Archiving the feedback allows for future statistical analysis using this data.

With respect to a voting threshold for new entries, the [toc_votes] table aggregates all entries that deemed to be equivalent (e.g., album, artist, and track names are the same). No entries are included in the database feed until a complete entry has multiple votes (e.g., three).

In FIG. 8, PK refers to Primary Key, FK refers to Foreign Key, AK refers to Alternate Key, U refers to Unique, and I refers to Index. In addition, the cardinality of the relationships among tables in the user feedback data schema is indicated as follows: One to Many (1 . . . *); One to One (1 . . . 1); and Zero or More (*).

FIG. 9 shows one example of a general purpose computing device in the form of a computer 70. In one embodiment of the invention, a computer such as the computer 70 is suitable for use in executing media player program 166.

In the illustrated embodiment, computer 70 has one or more processors or processing units 72 and a system memory 74. A system bus 76 couples various system components including the system memory 74 to the processors 72. The bus 76 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 70 has at least some form of computer readable media in FIG. 9. Computer readable media may be any available medium that can be accessed locally or remotely by computer 70. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by computer 70. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 74 includes computer storage media in the form of removable and/or non-removable, volatile and/or nonvolatile memory. In the illustrated embodiment, system memory 74 includes read only memory (ROM) 78 and random access memory (RAM) 80. A basic input/output system 82 (BIOS), containing the basic routines that help to transfer information between elements within computer 70, such as during startup, is typically stored in ROM 78. The RAM 80 typically contains data and/or program modules that are immediately accessible to and/or presently being operated on by processing unit 72. By way of example, and not limitation, FIG. 9 illustrates operating system 84, application programs 86 (e.g., media player 166), other program modules 88, and program data 90.

The computer 70 may also include other removable/non-removable, volatile/nonvolatile computer storage media. For example, FIG. 9 illustrates a hard disk drive 94 that reads from or writes to non-removable, nonvolatile magnetic media. FIG. 9 also shows a magnetic disk drive 96 that reads from or writes to a removable, nonvolatile magnetic disk 98, and an optical disk drive 100 that reads from or writes to a removable, nonvolatile optical disk 102 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 84, and magnetic disk drive 96 and optical disk drive 100 are typically connected to the system bus 76 by a non-volatile memory interface, such as interface 106.

The drives or other mass storage devices and their associated computer storage media discussed above and illustrated in FIG. 9, provide storage of computer readable instructions, data structures, program modules and other data for the computer 70. In FIG. 9, for example, hard disk drive 94 stores operating system 110, application programs 112, other program modules 114, and program data 116. Note that these components can either be the same as or different from operating system 84, application programs 86, other program modules 88, and program data 90. Operating system 110, application programs 112, other program modules 114, and program data 116 are given different numbers here to illustrate that, at a minimum, they are different copies.

For purposes of illustration, programs and other executable program components, such as the operating system 84, 110, are illustrated herein as discrete blocks. It is recognized, however, that such programs and components reside at various times in different storage components of the computer, and are executed by the data processor(s) of the computer. For example, FIG. 9 shows media player 166 stored in system memory 74. Those skilled in the art understand that components of media player 166 may reside in system memory 74, hard disk drive 94, or both.

Referring further to FIG. 9, a user may enter commands and information into computer 70 through input devices such as a keyboard 120 and a pointing device 122 (e.g., a mouse, trackball, pen, or touch pad). Other input devices known in the art include an audio/video input device(s) 123 as well as a microphone, joystick, game pad, satellite dish, scanner, or the like (not shown). These and other input devices are connected to processing unit 72 through a user input interface 124 that is coupled to system bus 76, but may be connected by other interface and bus structures, such as a parallel port, game port, or a universal serial bus (USB). As is well known in the art, application programs 86,112 are often configured to present a user interface (UI). The UI allows a user to interact with the application program in some manner using some type of input device (e.g., keyboard 120 or pointing device 122). This UI is typically a visual display that is capable of receiving user input and processing that user input in some way. By way of example, the UI presents one or more buttons or controls that can be clicked on by a user.

A monitor 128 or other type of display device is also connected to system bus 76 via an interface, such as a video interface 130. In addition to the monitor 128, computers often include other peripheral output devices (not shown) such as a printer and speakers, which may be connected through an output peripheral interface (not shown).

The computer 70 may operate in a networked environment using logical connections to one or more remote computers, such as a remote computer 134. The remote computer 134 may be a personal computer, a server, a router, a network PC, a peer device or other common network node, and typically includes many or all of the elements described above relative to computer 70. The logical connections depicted in FIG. 9 include a local area network (LAN) 136 and a wide area network (WAN) 138, but may also include other networks. Such networking environments are commonplace in offices, enterprise-wide computer networks, intranets, and global computer networks (e.g., the Internet).

When used in a local area networking environment, computer 70 is connected to the LAN 136 through a network interface or adapter 140. When used in a wide area networking environment, such as the Internet, computer 70 typically includes a modem 142 or other means for establishing communications over the WAN 138. The modem 142, which may be internal or external, is connected to system bus 76 via the user input interface 124, or other appropriate mechanism. In a networked environment, program modules depicted relative to computer 70, or portions thereof, may be stored in a remote memory storage device (not shown). By way of example, and not limitation, FIG. 9 illustrates remote application programs 144 as residing on the memory device. It will be appreciated that the network connections shown are exemplary and other means of establishing a communications link between the computers may be used.

Generally, the data processors of computer 70 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described below.

Although described in connection with an exemplary computing system environment, including computer 70, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 70 executes computer-executable instructions such as those described above to provide improved processing of user-provided metadata to enhance user experience when playing various media, including CDs and DVDs. The invention gives separate consideration to matching, adding, and editing metadata records. Further, the invention advantageously uses performer and album avatars to aggregate user data on a per field basis relative to performer and album, respectively. The album avatar also provides detail level aggregation heretofore unavailable in the prior art. Large scale aggregation techniques of the invention permit counting and maintaining votes per physical media descriptor.

The computer-executable instructions execute a media player program to render media files to users and to assist in collecting user-provided data entries. These data entries each correspond to a specific media file and relate to its content. The computer 70 also implements a server for determining relationships between the data entries, aggregating the data entries based thereon, and defining one or more new metadata records in a metadata database from the aggregated data entries.

In another embodiment, computer 70 defines a model record, or avatar, based on a property of content-related data and performs per field conflict resolution on the content-related data in the data entries. Based on the per field conflict resolution, the server computer populates the avatar and defines one or more new metadata records in the metadata database from the avatar.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of processing metadata comprising:
maintaining a database of metadata records, said metadata records each corresponding to one or more media files and relating to content of the corresponding media files, said media files being adapted for rendering by a media player program executed on one or more client computers;
collecting a plurality of user-provided data entries from the client computers, said data entries each corresponding to a specific media file and relating to the content of the corresponding specific media file;
determining relationships between the data entries and aggregating the data entries based thereon; and
defining one or more new metadata records in the metadata database from the aggregated data entries.

2. The method of claim 1 further comprising receiving, by a server associated with the metadata database, an identifier representative of the specific media file for each of the data entries from the client computers, said client computers and said server being coupled to a data communication network, and searching the metadata database for metadata records corresponding to the specific media file as a function of the identifier.

3. The method of claim 2 further comprising proceeding with collecting a plurality of user-provided data entries from the client computers if no metadata record corresponding to the specific media file represented by the identifier is found.

4. The method of claim 2 further comprising retrieving each of the metadata records found in the metadata database corresponding to the specific media file represented by the identifier, formatting the retrieved metadata records for rendering by the media player program, and returning the formatted metadata records via the data communication network to the respective client computer for rendering with the corresponding specific media file.

5. The method of claim 2 wherein the specific media file includes digital content of one or more tracks of a compact disc and wherein the identifier is representative of offset of the tracks on the disc.

6. The method of claim 2 wherein the specific media file includes digital content of a digital versatile disc and wherein the identifier is representative of menu information on the disc.

7. The method of claim 2 wherein the identifier comprises a physical ID and further comprising mapping the physical ID to a logical ID, said logical ID being representative of content characteristics of the specific media file and configured for use in querying the metadata database.

8. The method of claim 7 wherein searching the metadata database for metadata records corresponding to the specific media file comprises attempting to identify whether the logical ID already exists for the specific media file.

9. The method of claim 1 wherein determining relationships between the data entries and aggregating the data entries based thereon comprise defining a model record from one or more of the data entries based on at least one property of content-related data and applying subsequent user-provided data entries to the model record based on the property.

10. The method of claim 9 further comprising performing text matching to determine which of the data entries contain content-related data matching the model record.

11. The method of claim 9 wherein applying subsequent user-provided data entries to the model record comprises performing per field conflict resolution on the content-related data in the data entries.

12. The method of claim 11 wherein performing per field conflict resolution comprises populating the model record with the most frequently entered content-related data contained in the subsequent user-provided data entries.

13. The method of claim 9 wherein the at least one property of content-related data contains information identifying a performer of the content of the corresponding specific media file.

14. The method of claim 9 wherein the at least one property of content-related data contains information identifying a title of the content of the corresponding specific media file.

15. The method of claim 9 wherein the specific media file includes digital content of one or more tracks of a compact disc and wherein the at least one property of content-related data contains information representative of offset of the tracks on the disc.

16. The method of claim 9 wherein the specific media file includes digital content of a digital versatile disc and wherein the at least one property of content-related data contains information representative of menu information on the disc.

17. The method of claim 1 wherein the data entries contain content-related data in a plurality of fields and wherein determining relationships between the data entries and aggregating the data entries based thereon comprise performing per field conflict resolution on the content-related data.

18. The method of claim 1 further comprising storing the plurality of user-provided data entries from the client computers for subsequent processing, said user-provided data entries being stored separately from the aggregated user-provided data entries from which the newly defined metadata records are defined.

19. The method of claim 1 wherein maintaining the metadata database comprises maintaining a canonical table of the metadata records that contain content-related data obtained from one or more trusted sources and further comprising preventing the content-related data of the newly defined metadata records from supplanting the content-related data of the metadata records in the canonical table for the corresponding media files.

20. The method of claim 1 further comprising updating the metadata records in the metadata database with the newly defined metadata records.

21. The method of claim 1 further comprising defining a user feedback data schema for the data entries, said schema having a base table identifying each of the data entries collected from the client computers and a plurality of related tables organizing the content-related data of the data entries.

22. The method of claim 21 wherein the specific media file for each of the data entries from the client computers has an identifier representative thereof and wherein the related tables of the user feedback data schema include an identifier table for storing matches and modifications to the identifiers.

23. The method of claim 21 wherein the related tables of the user feedback data schema include an album table for storing new album entries and modifications to album name and/or performer associated therewith.

24. The method of claim 22 wherein the album table contains content-related data from the user-provided data entries and wherein the content-related data is selected from one or more of the following: title, performer, primary artist, and genre.

25. The method of claim 21 wherein the related tables of the user feedback data schema include a person table for storing new and modified names of performers not included in another of the related tables.

26. The method of claim 25 wherein the person table contains content-related data from the user-provided data entries and wherein the content-related data is selected from one or more of the following: full name of performer, sort name of performer, and genre.

27. The method of claim 21 wherein the related tables of the user feedback data schema include a track table for storing additions and modifications to track information for the media files.

28. The method of claim 1 wherein the metadata records each contain content-related data and wherein the content-related data is selected from one or more of the following: title, composer, performer, genre, studio, director, rating, art, and description of content of the corresponding media file.

29. The method of claim 1 wherein collecting a plurality of user-provided data entries from the client computers comprises causing a wizard user interface to be presented to a user via the respective client computer so that information pertaining to the user's specific media file can be collected from the user.

30. The method of claim 1 wherein one or more computer-readable media have computer-executable instructions for performing the method of claim 1.

31. A method of processing metadata comprising:
collecting a plurality of user-provided data entries from one or more client computers, said data entries each corresponding to a specific media file and relating to content of the corresponding specific media file, said media files being adapted for rendering by a media player program executed on the client computers;
defining a model record from one or more of the data entries based on at least one property of content-related data;
performing per field conflict resolution on the content-related data in the data entries;
populating the model record based on the per field conflict resolution; and
defining one or more new metadata records in the metadata database from the model record.

32. The method of claim 31 further comprising performing text matching to determine which of the data entries contain content-related data matching the model record.

33. The method of claim 31 wherein the per field conflict resolution comprises determining the most frequently entered content-related data contained in the user-provided data entries.

34. The method of claim 31 wherein the at least one property of content-related data contains information identifying a performer of the content of the corresponding specific media file.

35. The method of claim 31 wherein the at least one property of content-related data contains information identifying a title of the content of the corresponding specific media file.

36. The method of claim 31 wherein the specific media file includes digital content of one or more tracks of a compact disc and wherein the at least one property of content-related data contains information representative of offset of the tracks on the disc.

37. The method of claim 31 wherein the specific media file includes digital content of a digital versatile disc and wherein the at least one property of content-related data contains information representative of menu information on the disc.

38. The method of claim 31 further comprising receiving, by a server associated with the metadata database, an identifier representative of the specific media file for each of the data entries from the client computers, said client computers and said server being coupled to a data communication network, and searching the metadata database for metadata records corresponding to the specific media file as a function of the identifier.

39. The method of claim 38 further comprising retrieving each of the metadata records found in the metadata database corresponding to the specific media file represented by the identifier, formatting the retrieved metadata records for rendering by the media player program, and returning the formatted metadata records via the data communication network to the respective client computer for rendering with the corresponding specific media file.

40. The method of claim 38 wherein the specific media file includes digital content of one or more tracks of a compact disc and wherein the identifier is representative of offset of the tracks on the disc.

41. The method of claim 38 wherein the specific media file includes digital content of a digital versatile disc and wherein the identifier is representative of menu information on the disc.

42. The method of claim 38 wherein the identifier comprises a physical ID and further comprising mapping the physical ID to a logical ID, said logical ID being representative of content characteristics of the specific media file and configured for use in querying the metadata database.

43. The method of claim 42 wherein searching the metadata database for metadata records corresponding to the specific media file comprises attempting to identify whether the logical ID already exists for the specific media file.

44. The method of claim 31 wherein maintaining the metadata database comprises maintaining a canonical table of the metadata records that contain content-related data obtained from one or more trusted sources and further comprising preventing the content-related data of the newly defined metadata records from supplanting the content-related data of the metadata records in the canonical table for the corresponding media files.

45. The method of claim 31 further comprising updating the metadata records in the metadata database with the newly defined metadata records.

46. The method of claim 31 wherein the metadata records each contain content-related data and wherein the content-related data is selected from one or more of the following: title, composer, performer, genre, studio, director, rating, art, and description of content of the corresponding media file.

47. The method of claim 31 wherein collecting a plurality of user-provided data entries from the client computers comprises causing a wizard user interface to be presented to a user via the respective client computer so that information pertaining to the user's specific media file can be collected from the user.

48. The method of claim 31 wherein one or more computer-readable media have computer-executable instructions for performing the method of claim 31.

49. A system for processing user feedback comprising:
one or more client computers coupled to a data communication network, said client computers executing a media player program for rendering media files to users of the client computers;
a database of metadata records, said metadata records each corresponding to one or more media files and relating to content of the corresponding media files;
a database of user-provided data entries from the client computers, said data entries each corresponding to a specific media file and relating to the content of the corresponding specific media file; and
a server coupled to the data communication network, said server being associated with the databases and receiving the user-provided data entries via the data communication network, said server determining relationships between the data entries, aggregating the data entries based thereon, and defining one or more new metadata records in the metadata database from the aggregated data entries.

50. The system of claim 49 wherein the specific media file for each of the data entries from the client computers has an identifier representative thereof and wherein the server conducts a search the metadata database for metadata records corresponding to the specific media file as a function of the identifier.

51. The system of claim 50 wherein the specific media file includes digital content of one or more tracks of a compact disc and wherein the identifier is representative of offset of the tracks on the disc.

52. The system of claim 50 wherein the specific media file includes digital content of a digital versatile disc and wherein the identifier is representative of menu information on the disc.

53. The system of claim 49 further comprising a model record defined from one or more of the data entries based on at least one property of content-related data, and wherein the server applies subsequent user-provided data entries to the model record based on the property.

54. The system of claim 53 wherein the server performs text matching to determine which of the data entries contain content-related data matching the model record.

55. The system of claim 53 wherein the server performs per field conflict resolution on the content-related data in the data entries.

56. The system of claim 55 wherein the server populates the model record with the most frequently entered content-related data contained in the subsequent user-provided data entries.

57. The system of claim 53 wherein the at least one property of content-related data contains information identifying a performer of the content of the corresponding specific media file.

58. The system of claim 53 wherein the at least one property of content-related data contains information identifying a title of the content of the corresponding specific media file.

59. The system of claim 53 wherein the specific media file includes digital content of one or more tracks of a compact disc and wherein the at least one property of content-related data contains information representative of offset of the tracks on the disc.

60. The system of claim 53 wherein the specific media file includes digital content of a digital versatile disc and wherein the at least one property of content-related data contains information representative of menu information on the disc.

61. The system of claim 49 wherein the data entries contain content-related data in a plurality of fields and wherein the server performs per field conflict resolution on the content-related data to aggregate the data entries.

62. The system of claim 49 wherein the metadata database includes a canonical table of the metadata records that contain content-related data obtained from one or more trusted sources and wherein data conflicts are resolved in favor of the canonical table.

63. The system of claim 49 wherein the metadata records in the metadata database are updated with the newly defined metadata records.

64. The system of claim 49 wherein the newly defined metadata records do not contain redundant data with respect to the other metadata records.

65. The system of claim 49 wherein the metadata records each contain content-related data and wherein the content-related data is selected from one or more of the following: title, composer, performer, genre, studio, director, rating, art, and description of content of the corresponding media file.

66. The system of claim 49 further comprising a wizard user interface to be presented to a user via the respective client computer so that information pertaining to the user's specific media file can be collected from the user.

67. A user feedback data schema comprising:
a base table identifying each of a plurality of user-provided data entries collected from one or more client computers, said data entries each corresponding to a specific media file and relating to content of the corresponding specific media file, said media file being adapted for rendering by a media player program executed on the client computers; and
a plurality of tables related to the base table each for organizing content-related data of the data entries, said related tables organizing selected content-related data in different tables for feeding directly to a database of metadata records, said metadata records each corresponding to one or more media files and relating to the content of the corresponding media files.

68. The schema of claim 67 wherein the related tables include an album table for storing new album entries and modifications to album name and/or performer associated therewith.

69. The schema of claim 68 wherein the album table contains content-related data from the user-provided data entries and wherein the content-related data is selected from one or more of the following: title, performer, primary artist, and genre.

70. The schema of claim 67 wherein the related tables include a person table for storing new and modified names of performers not included in another of the related tables.

71. The schema of claim 70 wherein the person table contains content-related data from the user-provided data entries and wherein the content-related data is selected from one or more of the following: full name of performer, sort name of performer, and genre.

72. The schema of claim 67 wherein the related tables include a track table for storing additions and modifications to track information for the media files.

73. The schema of claim 67 wherein the specific media file for each of the data entries from the client computers has an identifier representative thereof and wherein the related tables include an identifier table for storing matches and modifications to the identifiers.

74. The schema of claim 67 wherein the specific media file includes digital content of one or more tracks of a compact disc (CD) and wherein the related tables are organized according to a basic CD metadata schema.
